(19) United States
(12) Patent Application Publication
(10) Pub. No.: US 2015/0130622 A1
(43) Pub. Date: May 14, 2015

(54) APPARATUS AND METHOD FOR CONTROLLING A DEVICE

(71) Applicant: Intermatic Incorporated, Spring Grove, IL (US)

(72) Inventors: Rodney W. Scuka, McHenry, IL (US); Brian Daniel Lamberty, Genoa City, WI (US)

(73) Assignee: Intermatic Incorporated, Spring Grove, IL (US)

(21) Appl. No.: 14/078,213

(22) Filed: Nov. 12, 2013

(51) Int. Cl. G05B 11/01; G08B 21/18; H02J 9/06

(52) U.S. Cl. CPC G05B 11/01; H02J 9/061; G08B 21/18
USPC 340/635; 307/117; 307/64

(57) ABSTRACT

A method for controlling the application of a voltage supply to an electrical load is disclosed. A characteristic of the voltage supply is determined. In response, the method causes disconnection of a control signal from a contactor. Disconnecting the control signal causes the contactor to disconnect the voltage supply from the electrical load.

### FIELD

This application relates generally to controlling electrically powered devices. More specifically, this application relates to controlling the operation of inductive loads.

### BACKGROUND

A wide array of devices powered by electricity pervades every aspect of life. A non-limiting list of examples of devices includes refrigerators, air conditioners, furnaces, washers, dryers etc. These devices improve our everyday lives.

### BRIEF DESCRIPTION OF THE DRAWINGS

FIG. 1 is a block diagram of an example HVAC system in which an example protection device may operate to stop the operation of the HVAC system by interrupting control signals produced by a thermostat.

FIG. 2 is a block diagram of a general purpose control system in which an example protection device may operate to interrupt control signal.

FIG. 3 is a block diagram of another example system in which an example protection device may operate to stop operation of a device in response to detecting brownout conditions.

FIG. 4 is functional block diagram of another example protection device.

FIG. 5 is timing diagram that illustrates normal and brownout condition voltage levels.

FIG. 6 is a flow diagram of an example method that may be implemented in an example protection device.

### DETAILED DESCRIPTION

Apparatus described herein and methods implemented therein may inhibit or stop the operation of an electrical load by interrupting a control signal. An electrical load or simply a load is any device that operates when a voltage supply is applied or connected to the load. The control signal may cause the voltage supply to be applied to the device. By causing the voltage supply to be applied to the device, the control signal causes the device to operate. Interrupting the control signal may cause disconnection or removal of the voltage supply from the device. As a consequence of interrupting the control signal, the operation of the device may be stopped or inhibited. Causing the connection of a voltage supply to the device to a voltage supply or applying a voltage supply to the load may be referred to as turning on or switching on the device. Causing the disconnection of the voltage supply from the device may be referred to as turning off or switching off the device. The control signal may be an electrical signal that is communicated over a control line or wirelessly via a radio frequency channel.

Operating a device under abnormal conditions decreases the device's life. Abnormal conditions are conditions that may damage the device or cause suboptimal operation of the device. In an exemplary embodiment, the apparatus may interrupt a control signal to stop the operation of a device in response to detecting abnormal conditions. An apparatus that stops a device from operating under abnormal conditions in response to detecting the abnormal may be referred to as a protection device.

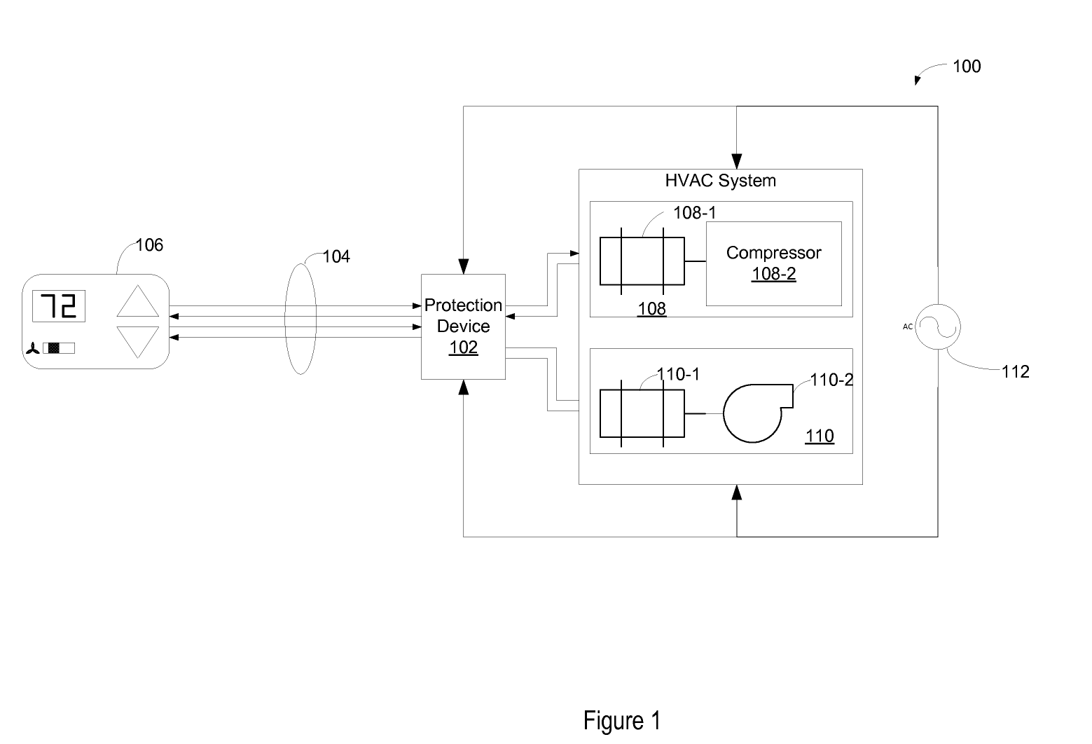

FIG. 1 is a block diagram of an example heating, ventilation and air conditioning (HVAC) system 100 in which an exemplary protection device 102 operates to interrupt control signals 104 generated by a thermostat 106. In this example, the HVAC system includes an AC unit 108 and a blower unit 110. The AC unit 108 includes an induction motor 108-1 and a compressor 108-2. The blower unit 110 includes an induction motor 110-1 that drives a fan 110-2. The protection device 102 is electrically disposed in the path of the control lines. Generally, the thermostat 106 senses the ambient temperature and attempts to maintain the ambient temperature near a desired set point temperature. The thermostat 106 does this by switching heating or cooling devices on or off, to maintain the temperature near the desired set point temperature.

During normal operation, the thermostat 106 turns on the induction motor 108-1 of the AC unit 108, in response to detecting that the ambient temperature exceeds the desired set point temperature. The thermostat generates a control signal on one of the control lines 104 to cause the induction motor 108-1 to turn on. One of ordinary skill in the art of HVAC may refer to this as the thermostat 106 “calling for cooling.” As initially discussed, the control signal may cause the voltage supply 112 to be applied to the induction motor 108-1. In response to the application of the voltage supply 112, the induction motor 108-1 may turn on and cause the compressor 108-2 to operate. Operation of the compressor 108-2 cools the air and reduces the ambient temperature. Separately, the thermostat 106 may cause the induction motor 110-1 of the blower unit 110 to turn on. The thermostat 106 may cause the induction motor 110-1 of the blower unit 110 to turn on by generating a control signal another of the control lines 104. The blower unit 110 when operating facilitates the circulation of the cooled air.

The voltage supply 112 is typically provided by electric utility or power companies. However, in some situations, the voltage supply may be generated locally by an electric generator, a solar panel, or a bank of batteries likes lead acid batteries etc. Common values of voltages supplied by power companies are 110 to 120 volts (AC) and 220 to 240 volts (AC). Generally, when the voltage supply 112 is applied to a device, the induction motor 108-1 for example, the device draws electric current. The instantaneous value of electric current drawn by the device depends on the value of the voltage supply and the electrical characteristics of the device. The product of the value of voltage supply and the electric current drawn by the device constitutes the electrical energy consumed by the device.

In this example, when the thermostat 106 determines that the ambient temperature is approximately equal to the desired set point temperature, the thermostat 106 may stop generating the control signal on the control lines 104. By stopping the generation of the control signals, the thermostat 106 may cause the voltage supply 112 to be removed from the induction motor 108-1. In response to the removal of the voltage supply 112, the induction motor 108-1 may turn off and cause the compressor to stop operating.

While the thermostat is generating the control signals on control lines 104, the protection device 102 may turn off one or both of the induction motors 108-1 and 110-1 by interrupting the control signals. Interrupting the control signals may cause the voltage supply 112 to be removed from the induction motors that drive the blower 110-2 and the compressor 108-2, in one embodiment. As will be discussed in detail later, the protection device 102 may include switches that when operated by elements of the protection device 102 may cause the interruption of the control lines carrying the control signals thereby interrupting the control signals.

In embodiments described herein, protection device 102 may cause the interruption of the control lines 104 in response to detecting abnormal conditions. The abnormal conditions may constitute physical conditions such as humidity, ambient temperature, temperature of the electrical load etc. In an embodiment, a protection device may include sensors that measure the physical conditions. For example, in one scenario a protection device 102 may measure the temperature of the induction motor 108-1, for example, and in response to detecting an excessive temperature the protection device 102 may stop the operation of the induction motor to protect the induction motor from damage.

In other scenarios, the abnormal conditions may be caused by variations in the characteristics of the voltage supply 112. Variations in the voltage supply 112 may be caused by extraneous factors like an increased demand placed on the electricity grid of the electric utility or power companies. Most devices are specified to operate with a nominal input voltage supply i.e. voltage supply±a percentage tolerance (input voltage supply range), for example, 120V±5%. A voltage supply that is above or below the input voltage supply range constitutes an abnormal condition. The condition where the voltage supply exceeds the input voltage supply range may be referred to as an over voltage condition. The condition where the voltage supply 112 is below the input voltage supply range may be referred to as an under voltage condition. An under voltage condition may be referred to as a brownout condition. For a voltage supply 112 of 120VAC, the brownout level is approximately 95 VAC and for a voltage supply of 240 VAC, the brownout level is approximately 188VAC.

During a brownout condition, a device such an induction motor 108-1 of AC unit 108 may draw more electric current to compensate for the decreased voltage supply. The increased electric current may cause the device to overheat, stall and even burnout, if the device is forced to operate for extended periods during a brownout. Other examples of abnormal voltage supply conditions include excessive phase differences between the voltage supply and the electric current, unbalanced phases in a three phase voltage supply etc. In embodiments described herein, the apparatus may monitor one or more of the above mentioned characteristics of the voltage supply. In an exemplary embodiment the apparatus may interrupt the control signal in response to detecting one or more of the discussed abnormal conditions associated with the voltage supply.

In the embodiment of FIG. 1, elements of the protection device 102 may cause the switches to operate in response to detecting the previously discussed abnormal conditions in the characteristics of the voltage supply 112. In the embodiment of FIG. 1, the protection device 102 is connected to the voltage supply 112. This enables the protection device 102 to monitor the status of the voltage supply 112.

By way of example and without limitation, the protection device 102 may detect over/under voltage conditions and in response may interrupt the control signals 104 to stop the induction motors from operating under over/under conditions.

By way of example and without limitation, in the foregoing, the protection device 102 operates to stop the operation of components of a HVAC. Protection device 102 may generally be employed to stop or control the operation of any device that converts electrical energy into one or more other forms of energy. Motors, pumps, motorized valves and blowers, are examples of electrical devices that convert electrical energy into motion and heat. A heating coil is an example of an electrical device that converts electrical energy into heat.

Protection device 102 may for example stop a kitchen oven from operating under abnormal conditions. Similarly, protection device 102 may stop a motor of a household washing machine in response to detecting abnormal conditions such as overflowing water, excessive water temperature etc.

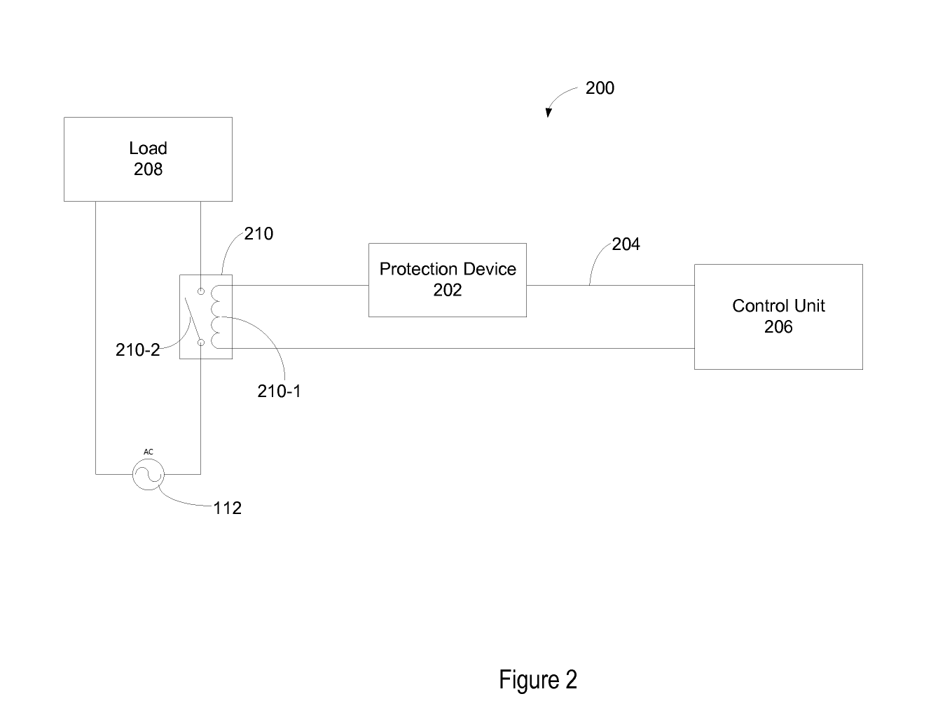

FIG. 2 depicts a block diagram of an example system 200 in which an exemplary device 202 may operate to stop the operation of an electrical load 208. Under normal operating conditions, a control unit 206 generates a control signal to cause load 208 to be turned on. The control unit 206 may correspond to the thermostat of FIG. 1, in an embodiment. The electrical signal is transmitted via a control line 204. The control line 204 may be connected to a single pole single throw (SPST) electromechanical relay 210. SPST relay 210 comprises a coil 210-1 and a switch 210-2. The electrical signal transmitted via the control line 204 may energize the coil 210-1 and cause the switch 210-2 to close. This causes the voltage supply 212 to be applied to the electrical load 208. Electric current will flow from the voltage supply 212 through the closed switch 210-2 and energize or turn on the electrical load 208.

Device 202 may interrupt the control signal produced by a control unit 206 on the control line 204 to inhibit the operation of an electrical load 208. Interrupting the control signal de-energizes the coil 210-1 and causes switch 210-2 to open. As a result, the voltage supply 212 is removed from the load 208 and the operation of the load 208 is stopped.

By way of example and without limitation, in the foregoing discussion, SPST electromechanical relay 210 is utilized to cause the application and removal of the voltage supply 212 to the electrical load 218. However, in other systems semiconductors devices like triacs or silicon controlled rectifiers may be utilized to cause the application and removal of the voltage supply 212 to the electrical load 218. In still other systems, a contactor may be utilized to cause the application and removal of the voltage supply 212 to the electrical load 218. A contactor is an electromechanical relay that can conduct large electric currents. The system 200 may correspond to heating, ventilation and cooling (HVAC) system of FIG. 1.

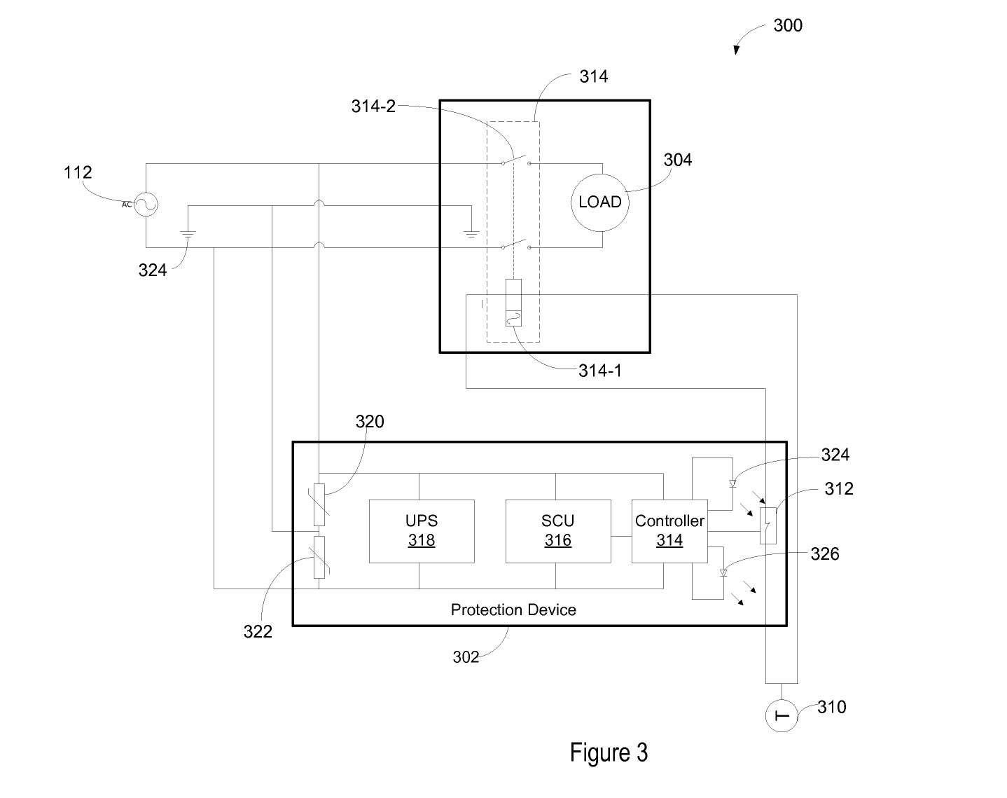

FIG. 3 illustrates an example HVAC system 300 where an exemplary protection device 302 may detect abnormal conditions corresponding to the voltage supply 112 and may stop the operation of motor 304. The motor 304 may correspond to the induction motor of AC unit of FIG. 1. Thermostat 310 may be configured to turn on motor 304 when the ambient temperature exceeds a set point temperature. In normal operation, thermostat 310 may produce or generate a 24 VAC control signal on control line 308 in response to determining that the ambient temperature exceeds the set point temperature. The control signal may be applied to contactor 314 via the electrical path comprising control line 308 and normally closed switch 312 of protection device 302. The control signal may energize coil 314-1 of contactor 314. The energized coil 314-1 may close the switches 314-2 and 314-3 thereby causing voltage supply 112 to be applied to the motor 304. In other embodiments, thermostat 310 may produce a 4-20 mA current signal to cause the contactor 314 to operate.

Protection device 302 may stop the operation of the motor 304 by interrupting the control signal produced by thermostat 310 on the control line 308. The protection device 302 may interrupt the control signal by causing the switch 312 to open and disconnect the control line 308. Interrupting the control signal causes coil 314-1 to de-energize. As a consequence switches 314-2 and 314-3 may open and remove the voltage 112 from the motor 304 thereby causing the motor 304 to turn off or shut down.

In this embodiment, in addition to switch 312, protection device 302 comprises controller 314, signal conditioning unit (SCU) 316, universal power supply (UPS) 318, varistors 320 and 322 and light emitting diodes (LEDs) 324 and 326. Controller 314 may communicate the operational status of protection device 302 by causing LEDs 324 and 326 to be illuminated in accordance with a pre-defined pattern.

SCU 316 comprises circuitry that generates a voltage signal representative of the voltage supply 112. Controller 314 may monitor the signal generated by SCU 316 and compare the signal to one or more thresholds. The thresholds may correspond to the input voltage supply range. In response to detecting that the signal is outside the input voltage supply range, the controller 314 may cause switch 312 to open. As previously explained, opening switch 312 causes the motor 304 to turn off. The controller 314 may communicate the status of the switch 312 by illuminating LED 324, in an embodiment.

In this embodiment, UPS 318, in normal operation, generates one or more DC supply voltages from voltage supply 112. The DC supply voltages generated by UPS 318 typically have a level of 12 V, 3.3V and 5V. The DC voltages generated by UPS 318 may be used to power the various components of the protective device 302. For example, the 3.3V DC supply voltage may power digital logic sections of the controller and the 12V and 5V DC supply voltages may power analog sections of the protective device 302. UPS 318 may be configured to operate across a wide range of values of voltage supply 112. UPS 318 may operate normally over a range of supply voltages. For example, UPS 318 may operate even when the voltage supply 112 drops to as low as 85 VAC or when the voltage supply surges to as high as 277 VAC. As a result, protective device 302 may continue to operate even when the voltage supply 112 drops to brownout voltage levels.

Generally, a varistor has a highly nonlinear current-voltage characteristic, in which the varistor has a high resistance at low voltages and a low resistance at high voltages. The varistors 320 and 322 are each connected between the voltage supply lines and earth 324 to protect the load 304 from transient voltages or surge voltages. Varistors 320 and 322 protect load 304 from excessive transient voltages by shunting the electric current created by the high transient voltage away from load 304. Varistors 320 and 322 remains non-conductive in a shunt-mode during normal operation when the voltage supply 112 is within normal operating range. When a voltage surge such as that caused by lightening, appears on the voltage supply lines, varistor 320 and varistor 322 may breakdown. As a result of this breakdown, the large current flow resulting from the voltage surge may be diverted to flow through varistor 320 and varistor 322 instead of load 304. After the voltage surge dissipates, the varistors 320 and 322 return to their non-conductive state.

Application of repetitive voltage surges in some instances may cause the varistors 320 and 322 to fail irreversibly. In some situations, repetitive voltages surges may cause the varistors 320 and 322 to breakdown irreversible. In other situations, after being subject to multiple voltage surges varistors 320 and 322 may fail to breakdown when a subsequent voltage surge appears on the voltage supply lines.

The varistors 320 and 322 may correspond to a thermal metal oxide varistor (TMOV), in some embodiments. An example of a TMOV that may be used as varistor 320 and 322 is the TCMOV34S111MP manufactured by LITTELFUSE. The TCMOV34S111MP is provided with a monitor line or lead (not shown). The monitor line indicates the normal operation state of the TCMOV34S111MP. The monitor lead may change state when the TCMOV34S111MP fails irreversibly. Controller 314 may monitor the state of the monitor lead and based on the state of the monitor line, controller 314 may appropriately cause a visual indicator such as the light emitting diode 326, for example, to illuminate in order to communicate the operational status of the varistors 320 and 322. Table 1 lists the states of the LEDs 324 and 326 under different operating conditions, in accordance with an embodiment. By way of example and without limitation, the protection device 300 is configured with two LEDs 324 and 326. In other embodiments, fewer or more LEDs may be coupled to the controller 314. In still other embodiments, controller 314 may operate an aural device such as a buzzer to communicate operation status of the protection device.

TABLE 1
LED Indicators

| Condition | LED 324 | LED 326 |
|---|---|---|
| Protection Device OK | ON | OFF |
| TMOV failed | OFF | OFF |
| Under Voltage | ON | Flash |
| Short Cycle Protect | Flash | OFF |
| Power Loss | OFF | OFF |

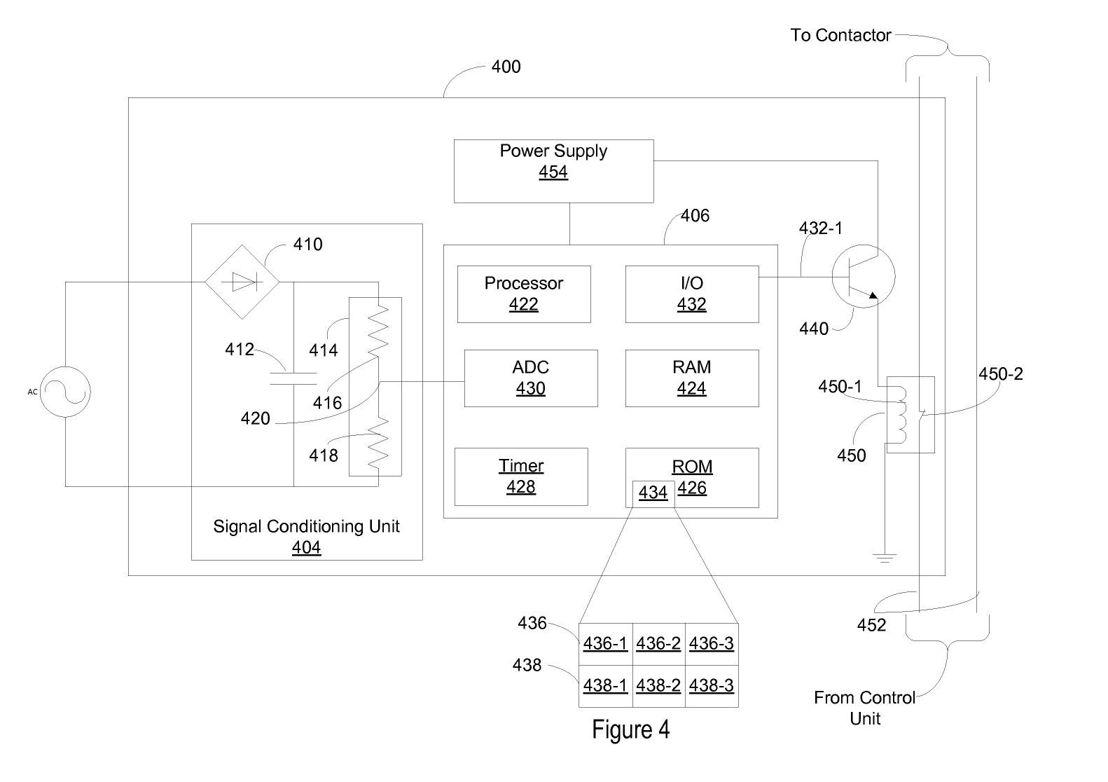

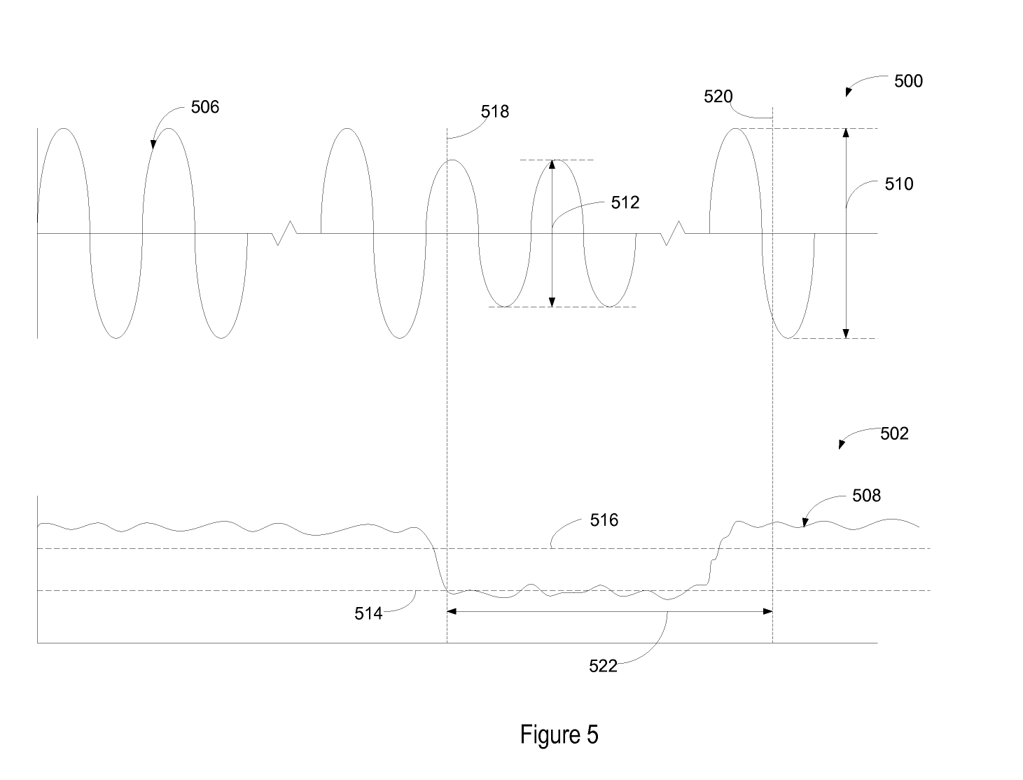

FIG. 4 is a detailed functional block diagram of an example protection device 400. The protection device 400 may correspond to the protection device 302, in an embodiment. In describing protection device 400, reference is made to timing diagrams 500 and 502 illustrated in FIG. 5. Time is represented on the horizontal axis of timing diagrams 500 and 502. AC sinusoidal voltage signal 506 may correspond to voltage supply 112 of FIG. 1. Under normal conditions, AC sinusoidal voltage signal 506 has an amplitude 510. Under abnormal conditions, such as brownout conditions, AC sinusoidal voltage signal 506 has an amplitude 512 that is less than the amplitude 510.

In this example, protection device 400 comprises a SCU 404, a controller 406, an NPN transistor 440, power supply 454 and an electromechanical normally closed relay 450. One end of control lines 452 may be connected to a control unit, for example thermostat 310 of FIG. 3. The other end of control lines 452 may be connected to a switch, for example contactor 314 of FIG. 3.

Power supply 454 operates to generate supply voltages to power the controller 406 and electromechanical normally closed relay 450, in this embodiment. Power supply 454 may correspond to the UPS 318 depicted in FIG. 3, in an embodiment. In this embodiment, power supply 454 may be connected to the voltage supply 112. In some embodiments, power supply 454 may comprise a step down transformer and one or more voltage regulators such as the 7505, 7512 etc. In still other embodiments, power supply 454 may correspond to a battery pack.

The SCU comprises rectifier 410, capacitor 412 and voltage divider 414. Rectifier 410 produces a constant polarity voltage signal or rectified voltage signal from the alternating polarity AC sinusoidal voltage signal 506 depicted in timing diagram 500. By way of example and without limitation, rectifier 410 may correspond to a full-wave diode bridge rectifier, in an embodiment. Capacitor 412 produces a filtered DC voltage signal based on the rectified voltage signal produced by the rectifier 410. In other embodiments, capacitor 412 may be replaced or augmented with additional components to produce the filtered DC voltage signal. The signal level of the filtered DC voltage signal is representative of the AC sinusoidal voltage signal 506.

By way of example and without limitation, voltage divider 414 is used to produce an electrical signal representative of the AC sinusoidal voltage signal 506. In operation, voltage divider 414 produces a low voltage electrical signal that is representative of the filtered DC voltage signal. In this example voltage divider 410 comprises resistors 416 and 418. Timing diagram 502 depicts the voltage signal 508 generated by voltage divider 414 at the voltage divider junction 420 of the resistors 416 and 418. Appropriate resistance values for the resistors 416 and 418 may be selected to produce a to a low voltage signal 508 proportional to AC sinusoidal voltage signal 506.

In this example, controller 406 comprises processor 422, random access memory (RM) 424, read only memory (ROM) 426, timer 428, analog to digital convertor (ADC) 430 and input/output (I/O) 432. In an embodiment, some or all of the method steps for detecting abnormal conditions associated with the AC sinusoidal voltage signal 506 and operating electromechanical normally-closed relay 450 to cause the interruption of the control signal 452 generated by a control unit (not shown), may be performed by execution of software instructions by processor 422. The software instructions may be stored in ROM 426. On power on, processor 422 may cause the software instructions to be copied to RAM 424 wherefrom the processor may fetch and execute the software instructions. In some embodiments, controller 406 may correspond to a system on a chip (SOC) wherein all the elements of controller 406 are included in a single semiconductor package, the MC9RS08KA4 for example.

The processor 422 may execute software instructions that generate digital signal on the output lines of the I/O 432. For example, some of the I/O lines (not shown) may be connected to the previously discussed LEDs. The processor 422 may generate a digital signal at a pre-determined rate to cause the LEDs to illuminate in accordance with a pre-determined visual pattern. Examples of visual patterns are flashing the LEDs at different rates, turning on the LEDs etc. In this embodiment, one of the I/O lines 432-1 may be connected to the base of NPN transistor 440. The controller may generate a digital signal on the I/O line 432-1 to cause the coil 450-1 of electromechanical normally-closed relay 450 to energize. Energizing coil 450-1 may cause switch 450-2 to open, thereby interrupting the control signal generated by the control unit on control lines 452. By way of example and without limitation, NPN transistor 440 is utilized to energize coil 450-1. In other embodiments, any suitable silicon device such as field effect transistor (FET), MOSFET etc. may be used. In this embodiment, switch 450-2 is arranged serially or in-line with one of the control lines 452. In other embodiments, switch 450 may be connected between the control lines 452. Some of the I/O lines may be connected to the monitor leads of the MOVs 320 and 322 (FIG. 3), in an embodiment.

ADC 430 operates to convert the voltage signal 508 that is available at voltage divider junction 420 to a digital or binary number that represents the instantaneous amplitude of the voltage signal 508. The digital number may be referred to the digital representation of the instantaneous amplitude of the voltage signal 508. The processor 422 may compare the digital number to one or more threshold digital numbers or threshold levels to detect an under/over voltage condition of the voltage supply 112.

In this example, a threshold table 434 may be stored in ROM 426. The threshold table 434 may include entry 436 and 438. Entry 436 may include digital numbers that correspond to various thresholds for a voltage supply of 120V. Entry 438 may include digital numbers that correspond to various thresholds for a voltage supply of 240V. For example, threshold level 436-1 may correspond to amplitude 514 of the voltage signal 508. Amplitude 514 of the voltage signal 508 is representative of the brownout level of voltage supply 112, in this case 120V. In operation, processor 422 may execute a software instruction to instruct ADC 430 to convert the voltage signal available at voltage divider junction 420 to a digital number. The processor 422 may compare the digital number received from the ADC 430 with the digital number 436-1. In response to detecting that the digital number is less than the digital number 436-1, the processor may identify a brownout condition.

In response to identifying a brownout condition, the processor 422 may execute software instructions to cause a digital signal to be generated on I/O line 432-1. As previously discussed, generating a digital signal on I/O line 432-1 may cause the switch 450 to open and interrupt the control signal generated by the control unit on the control lines 452. Opening the switch 450 causes the control line to be disconnected from the contactor 314. Disconnecting the control line interrupts the control signal from operating the contactor 314 and may cause contactor 314 of FIG. 3 to remove voltage supply 112 from load 304.

The processor 422 may continue to monitor the voltage supply 112 by causing the ADC 430 to convert the voltage signal 508 that is available at voltage divider junction 420 to a digital number. The processor 422 may compare the digital number with digital number 436-2. In response to detecting that the digital number exceeds the digital number 436-2, the processor 422 may stop generating the digital signal on I/O line 432-1. This may cause the switch 450 to close. As a result the control signal generated by the control unit on the control lines 452 may be applied to the contactor 314. The digital number 436-2 may correspond to amplitude 516 of the voltage signal 508. The amplitude 516 of the voltage signal 508 may be referred to as the pickup level and may be referred to as the second threshold level.

In some embodiments, after causing the interruption of the control signal, processor 422 may configure a timer 428 with a timeout value. To prevent short cycling of the load 304, the processor 422 may continue to interrupt the control signal until the timer 428 expires even if the brownout condition resolves before expiration of the timer 428. The timeout value may correspond to the time interval 522, in an embodiment. The timeout value may be a determined time period, 10 seconds for example.

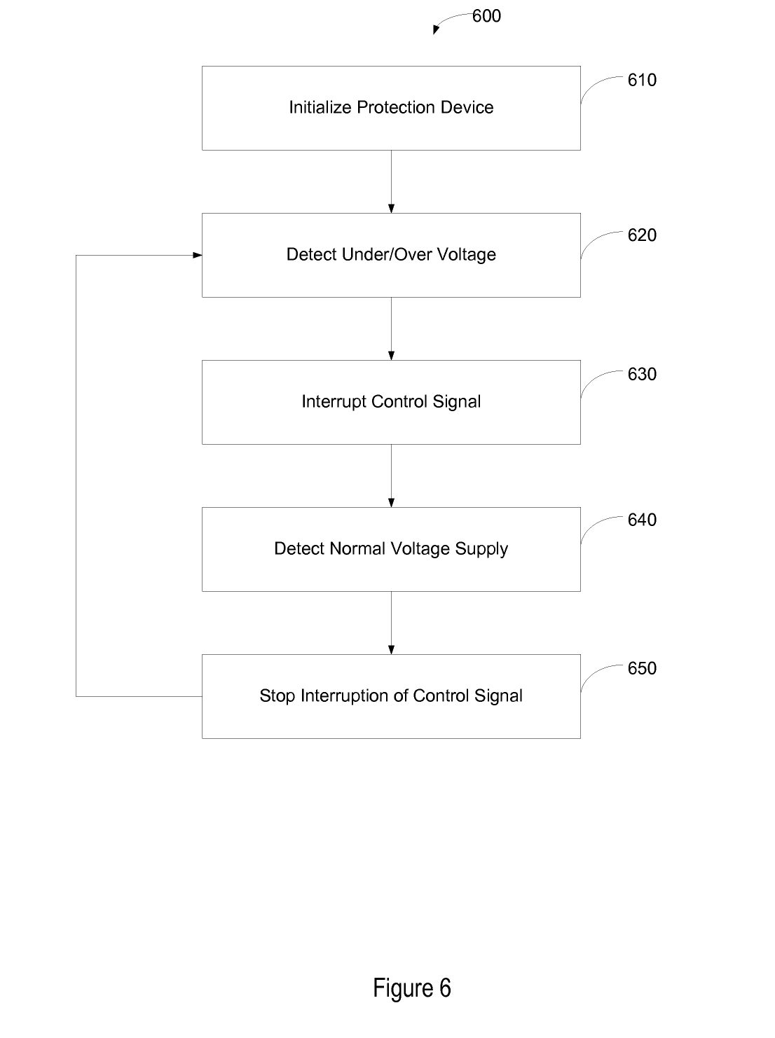

FIG. 6 is a flow diagram of an example method 600 that may be implemented to cause the interruption of a control signal in response to detecting under/over voltage conditions of the voltage supply 112. Method 600 may be implemented in protection device 400 of FIG. 4 to stop the operation of a device in response to detecting over/under voltage conditions.

At block 610, in response to a power on reset, the protection device 400 may be initialized. At block 610, software instructions may be copied from ROM 426 to RAM 424. In this embodiment, at block 610, processor 422 may cause the ADC 430 to convert the voltage signal 508 that is available at voltage divider junction 420 to a digital number. Based on the value of digital number, processor 422 may select one of the two threshold entries 436 or 438. As previously discussed, threshold entry 436 corresponds to voltage thresholds for a voltage supply of 120 V and entry 438 corresponds to voltage thresholds for a voltage supply of 240 V. At block 610, processor 422 may also illuminate LEDs 324 (FIG. 3) in accordance with Table 1 to indicate normal operation of the protection device.

At block 620, processor 422 may cause the ADC 430 to repeatedly convert, at regular intervals, the voltage signal generated at voltage divider junction 420. The processor 422 may average a series of digital numbers received from ADC 430 and compare the average to the brownout threshold 436-1 and the over voltage threshold 436-3, in an embodiment. At block 620, processor 422 may also monitor the monitor leads of MOVs 320 and 322 to determine the operational status of the MOVs 320 and 322. The processor 422 may appropriately illuminate the LEDs to indicate the operational status of the MOVs in accordance with a predetermined scheme. For example, with reference to table 1, processor 422 may turn of LED 324 in response to detecting that one or both of the MOVs 320 and 322 have failed.

In response to determining that the average is below the brownout threshold 436-1, in an embodiment, at block 630, processor 422 may generate a signal on I/O line 432-1. For example, with reference to FIG. 5, at time 518, processor 422 may detect the brownout condition. As previously discussed, generating a signal on I/O line 432-1 may cause the switch 450-2 to open thereby interrupting the control signal being generated by a thermostat from operating a contactor, for example. In accordance with table 1, in an embodiment, at block 630, processor 422 may cause LED 326 to flash to indicate the brownout condition. As previously discussed, in one embodiment, at block 630, processor 422 may configure timer 428 with a time period corresponding to time interval 522. Separately, in another embodiment, in response to determining that the average is above the over voltage threshold 436-3, processor 422 may, at block 630, interrupt the control signal generated by a thermostat.

In an embodiment, at block 640, in response to an expiration of the time interval as indicated by timer 428, processor 422 may cause the ADC 430 to repeatedly convert, at regular intervals, the voltage signal generated at voltage divider junction 420. ADC 430 produces a digital count proportional to the voltage signal at voltage divider junction 420. Processor 422 may average a series of digital counts and compare the average to pick-up threshold 436-2.

At block 650, in response to detecting that the average digital count exceeds pick-up threshold 436-2, processor 422 may stop generating the signal on I/O line 432-1 thereby causing the control signal being generated by a thermostat, for example, to be applied to a contactor. The processor may return to executing instructions corresponding to block 620.

Each of the methods described herein may be encoded in a computer-readable storage medium (e.g., a computer memory), programmed within a device (e.g., one or more circuits or processors), or may be processed by a controller or a computer. If the processes are performed by software, the software may reside in a local or distributed memory resident to or interfaced to a storage device, a communication interface, or non-volatile or volatile memory in communication with a transmitter. The memory may include an ordered listing of executable instructions for implementing logic. Logic or any system element described may be implemented through optic circuitry, digital circuitry, through source code, through analog circuitry, or through an analog source, such as through an electrical, audio, or video signal. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable storage medium,” “machine-readable medium,” “propagated-signal” medium, and/or “signal-bearing medium” may comprise a medium (e.g., a non-transitory medium) that stores, communicates, propagates, or transports software or data for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection having one or more wires, a portable magnetic or optical disk, a volatile memory, such as a Random Access Memory (RAM), a Read-Only Memory (ROM), an Erasable Programmable Read-Only Memory (EPROM or Flash memory), or an optical fiber. A machine-readable medium may also include a tangible medium, as the software may be electronically stored as an image or in another format (e.g., through an optical scan), then compiled, and/or interpreted or otherwise processed. The processed medium may then be stored in a computer and/or machine memory.

While various embodiments, features, and benefits of the present system have been described, it will be apparent to those of ordinary skill in the art that many more embodiments, features, and benefits are possible within the scope of the disclosure. For example, other alternate systems may include any combinations of structure and functions described above or shown in the figures.

1. An apparatus comprising:
a switch electrically connected with a control line, the control line electrically connecting a thermostat to a relay, the relay operable to electrically connect a voltage supply to a load in response to a signal generated on the control line; and
a controller electrically connected with the switch, the controller operable to control the switch to interrupt the control signal from reaching the relay.

2. The apparatus of claim 1 wherein the switch is electrically connected in series between the control line and the relay.

3. The apparatus of claim 1 further comprising a varistor wherein the varistor is electrically connected with the voltage supply.

4. The apparatus of 3 further comprising a visual indicator, the visual indicator electrically coupled with the controller wherein the controller is operable to cause the visual indicator to generate a visual pattern based on an operational status of the varistor.

5. The apparatus of claim 1 further comprising a circuit configured to produce an electrical output representative of the voltage supply.

6. The apparatus of claim 5 wherein the controller operates the switch based on the electrical output.

7. The apparatus of claim 1 further comprising a universal power supply (UPS) coupled with the voltage supply and operable to power the controller wherein the UPS is configured to operate over a range of supply voltages.

8. A method for controlling an application of a voltage supply to an electrical load, the method comprising:
determining by a processor a characteristic of the voltage supply; and
in response causing a disconnection of a control signal from a contactor wherein disconnecting the control signal causes the contactor to disconnect the voltage supply from the electrical load.

9. The method of claim 8 wherein the determined characteristic is the voltage supply exceeding a first threshold.

10. The method of claim 9 further comprising in response to causing a disconnection of the control signal, monitoring the characteristic of the voltage supply to determine if the characteristic of the voltage supply exceeds a second threshold level.

11. The method of claim 10 wherein in response to determining that the characteristic of the voltage supply is above the second threshold level causing a connection of the control signal to the contactor wherein connecting the control signal causes the contactor to connect the voltage supply to the electrical load.

12. The method of claim 11 further comprises maintaining disconnection of the control signal for a determined time period.

13. An apparatus comprising:
a normally closed switch comprising a first terminal, a second terminal and a control input, the first terminal adapted to be connected to a control line and the second terminal adapted to be connected to a contactor, wherein the contactor applies an electrical supply to an electrical load in response to a signal produced on the control line, the signal electrically conducted to the contactor via the normally closed switch; and
a controller comprising a first control output, the first control output coupled to the control input, the controller operable to generate a signal at the first output to cause the normally closed switch to open wherein opening the normally closed switch interrupts the signal produced on the control line.

14. The apparatus of claim 13 further comprises a voltage divider wherein the voltage divider is configured to generate a voltage signal representative of the electrical supply at a voltage divider junction.

15. The apparatus of claim 14 further comprises an analog to digital (ADC) convertor wherein an input of the ADC is coupled with the voltage divider junction and wherein the ADC is operable to produce a digital representation of the voltage signal.

16. The apparatus of claim 15 wherein the controller generates the signal at the first output based on the digital representation of the voltage signal.

17. The apparatus of claim 13 further comprising a varistor wherein the varistor is electrically connected with the electrical supply.

18. The apparatus of claim 17 wherein the varistor is a thermal metal oxide varistor (TMOV).

19. The apparatus of claim 18 wherein a monitor line of the TMOV is electrically coupled with a first input of the controller.

20. The apparatus of claim 13 further comprises a light emitting diode (LED) wherein the LED is electrically coupled with a second output of the controller, wherein the controller is operable to cause the LED to illuminate.
